(19) United States
(12) Patent Application Publication
(10) Pub. No.: US 2007/0264006 A1
(43) Pub. Date: Nov. 15, 2007

(54) Filter Driving Apparatus

(75) Inventor: Chun-Ru Huang, Taipei (TW)

Correspondence Address: LAW OFFICES OF LAI AND ASSOCIATES, P.C., 5800 RANCHESTER STE 200, HOUSTON, TX, 77036, US

(73) Assignee: AV TECH CORPORATION, Taipei Hsien (TW)

(21) Appl. No.: 11/307,792

(22) Filed: May 9, 2006

(51) Int. Cl. G03B 9/02

(52) U.S. Cl. 396/505

(57) ABSTRACT

A filter driving apparatus for a camera is described. The filter driving apparatus comprises a casing, a sliding portion, a magnetic body, and a coil portion. A viewing hole is formed on the central top area of the casing. A sliding channel is formed on the top and bottom area of the casing. The sliding portion slides in the sliding channel. A filter is set on the sliding portion and on the top area of the casing. The magnetic body is set on the bottom area of the casing. The magnetic body connects with the sliding portion. The coil portion is set on the bottom area of the casing. The coil portion generates a pole different from or the same with the magnetic body by inputting different currents, so that a repelling force or an engaging force is generated between the magnetic body and the coil portion. Therefore, the magnetic body could leave from or close to the coil portion, and the filter could be overlapped or removed from the viewing hole.

### FIELD OF THE INVENTION

The present invention relates to a filter driving apparatus and, more particularly, to a filter driving apparatus for a camera.

### BACKGROUND OF THE INVENTION

A filter for use with cameras is typically attached to the front of the camera lens. The filter is to insulate stray light and infrared rays (IR) cut. The light captured by the camera lens during the day may be too much such that it causes overexposed image; hence the filter is necessary for filtering invisible light like ultraviolet or infrared rays. When a picture is taken during the night, the light may be insufficient and even the light energy which can not be seen by eyes may increase the image resolution as well. Therefore, there is no need to filter light. The filter is not necessary and can be removed from the camera lens.

Referring to FIG. 8, a perspective drawing illustrates a conventional filter driving apparatus. The filter driving apparatus 80 comprises a casing 82, a sliding slice 88 and a driving motor 92. The casing 82 is a lamellar structure. A viewing hole 84 is set at a side of the casing 82. First fixing blocks 86 are set on a top and a bottom side of the casing 82 for fixing on the camera (not shown). In addition, second fixing blocks 96 are set at two sides of the casing 82. The sliding slice 88 can be set on the casing 82 by using a sliding way when the sliding slice 88 is held by the second fixing blocks 96. The sliding slice 88 has two viewing holes, wherein a filter 90 is set in one viewing hole. The driving motor 92 is set at the bottom side of the casing 82. A linkage 94 is set in a central axial of the driving motor and is connected to the sliding slice 88. The sliding slice 88 is then driven to move.

Referring to FIG. 9, a perspective drawing illustrates the conventional filter driving apparatus is in use. The linkage 94 is used by the driving motor 92 to drive the sliding slice 88 while a filter 90 is applied during the day. The viewing hole corresponding to the filter 90 can be aimed at the viewing hole 84 of the casing 82, so as to provide a filter motion for the camera lens. When the filter 90 is not in use during the night, the sliding slice 88 is driven by the driving motor 92. The viewing hole without the filter 90 can be aimed at the viewing hole 84 of the casing 82. The filter motion is therefore unnecessary.

However, the volume of the driving motor 92 is bigger. The driving motor 92 is too heavy and is impractical, as observed from a comparison with the volume of the casing 92. Moreover, the location for the camera placing and application is restricted as well. A filter driving apparatus with smaller volume must be provided to reduce the volume of the camera effectively. The filter driving apparatus is then placed into various spaces.

### SUMMARY OF THE INVENTION

Accordingly, the object of the present invention is to provide a filter driving apparatus that is applied for a camera. The filter can be moved by using the attractive force and the repulsive force between magnetic materials, so as to decrease volumes taken by the camera.

In accordance with the present invention the filter driving apparatus comprises a casing, a sliding portion, a magnetic body and a coil portion. A central top area of the casing has a viewing hole. A sliding channel is formed on a top and a bottom side of the casing. The sliding portion can be slid on the sliding channel. A filter is set on the sliding portion. The magnetic body is connected to the sliding portion. A magnetic field is generated that is the same as or differs from the polarity of the magnetic body when different current passes through the coil portion. An attractive force or the repulsive force is then generated between the coil portion and the magnetic body to attract or repel the magnetic body, thereby placing or withdrawing the filter from over the viewing hole.

Another object of the present invention is to provide a filter driving apparatus for a camera. The filter driving apparatus comprises a casing, a sliding portion, a magnetic body and a coil portion. A viewing hole is set upon a central top area of the casing. The position of the viewing hole corresponds to a camera lens of the camera. A sliding channel is formed on a top and a bottom side of the casing. The sliding portion can be slid on the sliding channel. A filter is set on the sliding portion. The magnetic body is connected to the sliding portion. A magnetic field is generated that is the same as or differs from the polarity of the magnetic body when the coil portion is electrified by different current. An attractive force or a repulsive force is then generated between the coil portion and the magnetic body to attract or repel the magnetic body to leave or inset the coil portion. Therefore, the filter can be placed over or removed from the viewing hole.

An axial of the coil portion parallels an axial of the magnetic body. If a polarity of the magnetic body is the same as a polarity of a magnetic field generated by the coil portion, an attractive force is then generated between the coil portion and the magnetic body to attract the magnetic body to move toward the coil portion. The filter is then placed over and overlapped the viewing hole. If the polarity of the magnetic body differs from the polarity of the magnetic field generated by the coil portion, a repulsive force is then generated between the coil portion and the magnetic body to repel the magnetic body to withdraw from the coil portion. The filter is then removed from the viewing hole.

Other features and advantages of the present invention and variations thereof will become apparent from the following description, drawings, and claims.

### BRIEF DESCRIPTION OF THE DRAWINGS

FIG. 1 is a schematic diagram illustrating a filter driving apparatus according to a preferred embodiment of the present invention;

FIG. 2 is a perspective drawing illustrating a filter driving apparatus removing a cover portion according to a preferred embodiment of the present invention;

FIG. 3 is a side elevation view illustrating a filter driving apparatus according to a preferred embodiment of the present invention;

FIG. 4 is a decomposition diagram illustrating a filter driving apparatus according to a preferred embodiment of the present invention;

FIG. 5 is a pictorial drawing illustrating in a filter driving apparatus when the filter is not in use according to a preferred embodiment of the present invention;

FIG. 6 is a pictorial drawing illustrating in a filter driving apparatus when the filter is in use according to a preferred embodiment of the present invention;

FIG. 7 is a perspective drawing illustrating a filter driving apparatus within a camera according to a preferred embodiment of the present invention;

FIG. 8 is a perspective drawing illustrating a conventional filter driving apparatus;

FIG. 9 is a perspective drawing illustrating a conventional filter driving apparatus is in use;

FIG. 10 is a perspective drawing illustrating a filter driving apparatus according to a preferred embodiment of the present invention;

FIG. 11 is an exploded assembly drawing illustrating a filter driving apparatus according to a preferred embodiment of the present invention;

FIG. 12 is a pictorial drawing illustrating when the filter is not in use for a filter driving apparatus according to a preferred embodiment of the present invention; and

FIG. 13 is a schematic diagram illustrating when the filter is in use for a filter driving apparatus according to a preferred embodiment of the present invention.

### DETAILED DESCRIPTION OF THE PREFERRED EMBODIMENTS

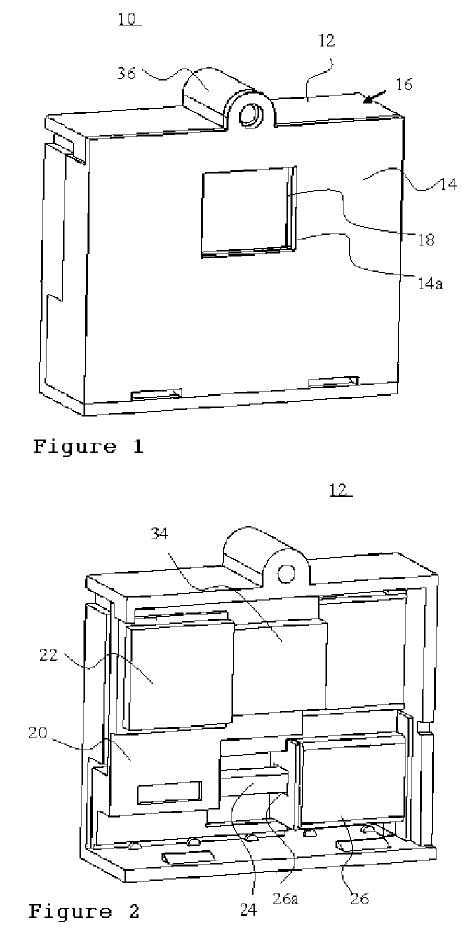

Referring to FIG. 1, a schematic diagram illustrates a filter driving apparatus according to a preferred embodiment of the present invention. A casing 16 of the filter driving apparatus 10 has a main body portion 12 and a cover portion 14. A fixing block 36 is set on a top of the main body portion 12 for fixing on a camera (as shown in FIG. 7). In addition, a central top area of the filter driving apparatus 10 has a viewing hole 18 of the main body portion 12 and a viewing hole 14a of the cover portion 14. The position of the viewing hole 18 corresponds to the viewing hole 14a for passing light beams.

Referring to FIG. 2, a perspective drawing illustrates the main body portion 12 of the filter driving apparatus 10 according to FIG. 1. The main body portion 12 has a sliding portion 20, a filter 22, a magnetic body 24 and a coil portion 26. The filter 22 is set on the sliding portion 20. The sliding portion 20 is connected to the magnetic body 24. The magnetic body 24 is a rod structure. At least one coil set is placed in the coil portion 26. An axial of the coil portion 26 parallels an axial of the magnetic body 24. An opening 26a is set at a center of the coil portion 26 for insetting an end of the magnetic body 24. Different polarities are generated based on different current directions when current passes through the coils, an attractive or a repulsive reaction is then generated between the magnetic body 24 and the coil portion 26. If an end of the magnetic body 24 is S pole (The end of the magnetic body 24 is near the coil portion 26), once current passes through the coil portion 26 and a magnetic field effect of N pole is generated from the coil portion 26, an attractive force is generated between the magnetic body 24 and the coil portion 26, or a repulsive force is generated between the magnetic body 24 and the coil portion 26 when current passes through the coil portion 26 and a magnetic field effect of S pole is generated from the coil portion 26. Alternately, if an end of the magnetic body 24 is N pole (The end of the magnetic body 24 is near the coil portion 26), once current passes through the coil portion 26 and a magnetic field effect of N pole is generated from the coil portion 26, a repulsive force is generated between the magnetic body 24 and the coil portion 26, or an attractive force is generated between the magnetic body 24 and the coil portion 26 when current passes through the coil portion 26 and a magnetic field effect of S pole is generated from the coil portion 26.

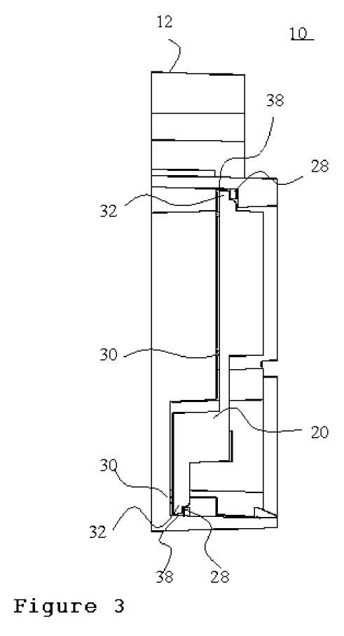

Referring to FIG. 3, a side elevation view illustrates the filter driving apparatus 10 according to FIG. 1. A top and a bottom side within the main body portion 12 have at least one protrusion 28. A sidewall of the casing 16 has a plurality of baffles 30. In addition, a top and a bottom side of the sliding portion 20 have ladder structures 32. The protrusion 28, the plurality of baffles 30 and the ladder structure 32 are formed channels 38. The sliding portion 20 can be slid along a presetting path. The protrusion 28 is uniformly distributed along the channels 38 and is for fastening the ladder structures 32. The plurality of baffles 30 is against the sliding portion 20 to steady the sliding portion 20 on the channels 38 without dropping while the sliding portion 20 is sliding.

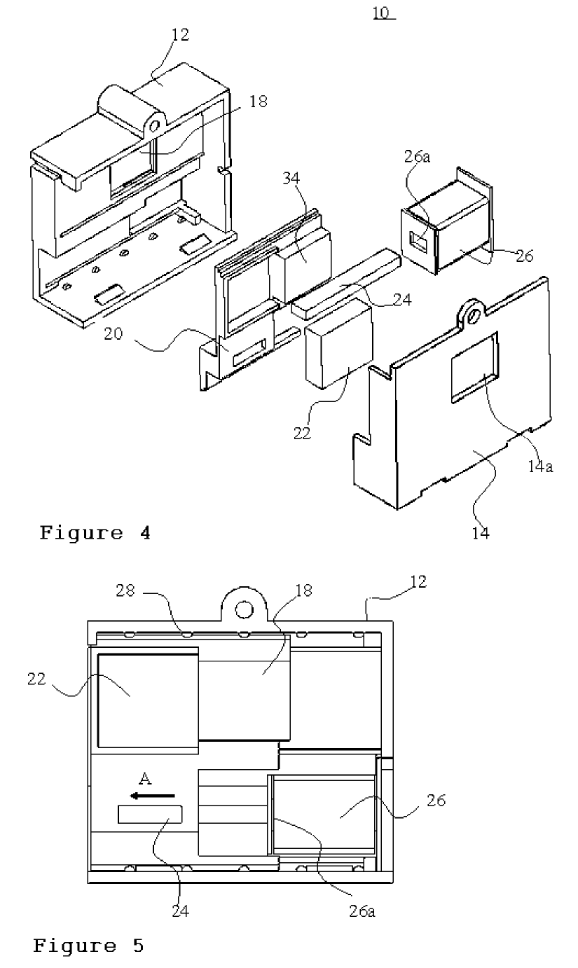

Referring to FIG. 4, an exploded diagram illustrates the filter driving apparatus 10 according to FIG. 1. The coil portion 26 has an opening 26a which corresponds to a central of coils. An end of the magnetic body 24 can be inset into the opening 26a of the coil portion 26. In addition, a central top area of the main body 12 has the viewing hole 18. The cover portion 14 has the viewing hole 14a. The position of the viewing hole 18 corresponds to the position of the viewing hole 14a. The viewing hole 18 overlaps the viewing hole 14a when the main body portion 12 is combined with the cover portion 14 as shown in FIG. 1.

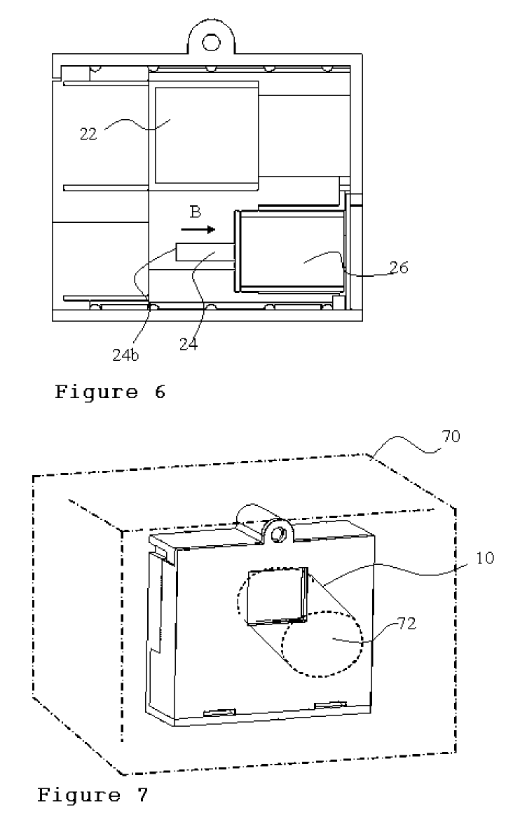

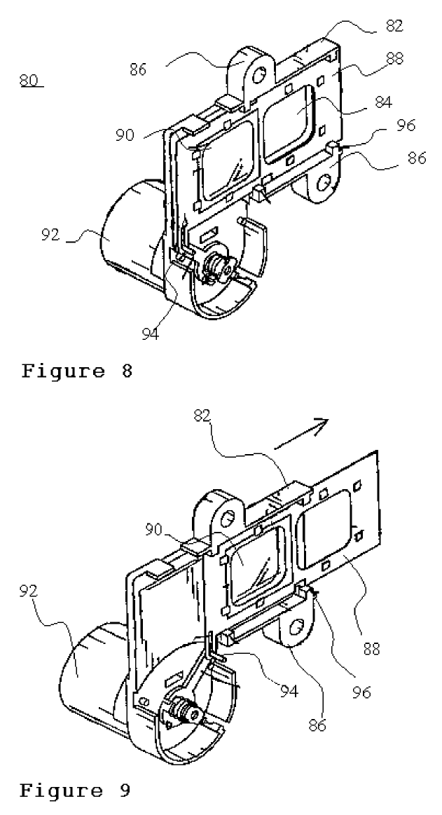

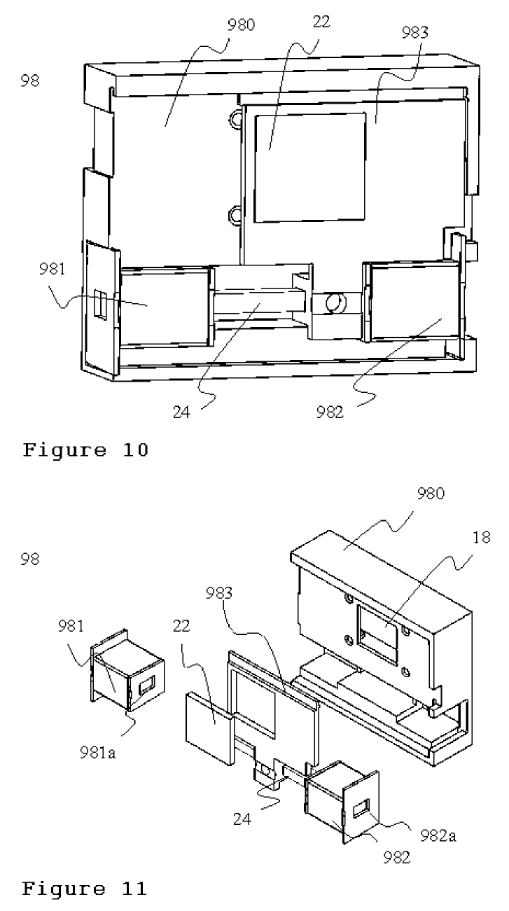

Referring to FIG. 5 to FIG. 7, FIG. 5 is a pictorial drawing illustrating the filter driving apparatus 10 according to FIG. 1 when the filter is not in use; and FIG. 6 is a pictorial drawing illustrating when the filter is in use. As shown in FIG. 7, the filter driving apparatus 10 of the present invention is applied for a camera lens 72 of a camera 70. The camera lens 72 uses a charge coupled device (CCD) or a complementary metal oxide semiconductor (CMOS) chip for the camera lens. The camera 70 can be used day and night. The camera lens 72 corresponds to the viewing hole 18 and the viewing hole 14a. When a picture is taken during the night, the filter 22 can be withdrawn from the viewing hole 18 as shown in FIG. 5. When current passes through the coil portion 26, the polarity of the magnetic field generated by the magnetic body 26 is then the same as the polarity of the magnetic body 24. A repulsive force is generated between the coil portion 26 and the magnetic body 24, the magnetic body 24 is therefore withdrawn from the coil portion 26 as A course. The magnetic body 24 is further taken out from the opening 26a of the coil portion 26 as shown in FIG. 5. For the filter 22 is set on the sliding portion 20 and the sliding portion 20 is connected to the magnetic body 24, the sliding portion 20 slides with the magnetic body 24. The filter 22 can be removed from the viewing hole 18. In addition, a transparent film 34 without light filtering is further provided for the present invention to increase more convenience in assembling such as a plastic sheet or a glass sheet. The transparent film 34 is covered on the viewing hole 18 as shown in FIG. 2. The size of the transparent film 34 is the same as the size of the viewing hole 18. The transparent film 34 is combined with the viewing hole 18 into a whole.

When a picture is taken during the day, the daylight is strong. The filter 22 is then needed for filtering the light energy which can not be seen by eyes like ultraviolet or infrared rays. The filter 22 is placed over the viewing hole 18 as shown FIG. 6. Current passes through the coil portion 26, the direction of the current is the reverse of the direction of the current illustrated by FIG. 5. An attractive force is then generated between the coil portion 26 and the magnetic body 24, hence the magnetic body 24 is moved toward the coil portion 26 as B course. The magnetic body 24 is inset into the opening 26a of the coil portion 26 as shown in FIG. 6. The filter 22 is set on the sliding portion 20. The sliding portion 20 is connected to the magnetic body 24. The sliding portion 20 slides with the magnetic body 24. The filter 22 is placed over and overlapped the viewing hole 18 as shown in FIG. 6.

Referring to FIG. 10 and FIG. 11, FIG. 10 is a perspective drawing illustrating the filter driving apparatus according to a preferred embodiment of the present invention and FIG. 11 is an exploded assembly drawing illustrating the filter driving apparatus. As shown in FIG. 10, a main body portion 980 of the filter driving apparatus 98 has a sliding portion 983, the filter 22, the magnetic body 24, a first coil portion 981 and a second coil portion 982. The filter 22 is set on the sliding portion 983. The sliding portion 983 is connected to the magnetic body 24. The magnetic body 24 is a rod structure. As shown in FIG. 11, at least one coil set is placed in the first coil portion 981. An axial of the first coil portion 981 parallels the axial of the magnetic body 24. An opening 981a is set in a center of the first coil portion 981 for insetting the end of the magnetic body 24. Different polarities are generated based on different current directions when current passes through the coils. An attractive or a repulsive reaction is then generated between the magnetic body 24 and the first coil portion 981. At least one coil set is placed in the second coil portion 982. An axial of the second coil portion 982 parallels the axial of the magnetic body 24. An opening 982a is set in a center of the second coil portion 982 for insetting the end of the magnetic body 24. Different polarities are generated based on different current directions when current passes through the coils, an attractive or a repulsive reaction is then generated between the magnetic body 24 and the second coil portion 982.

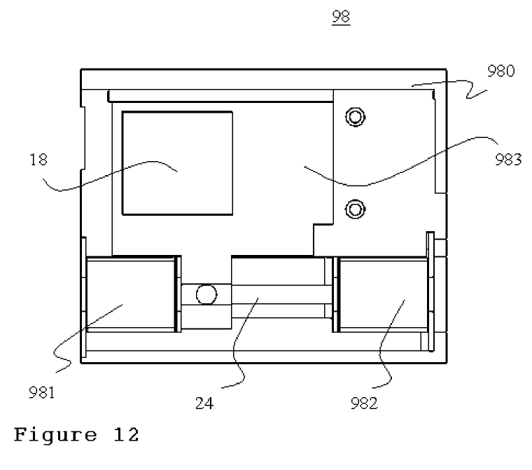

Referring to FIG. 12, a pictorial drawing illustrates when the filter is not in use for the filter driving apparatus. In the filter driving apparatus 98, if an end of the magnetic body 24 is S pole (The end of the magnetic body 24 is near the first coil portion 981) and another end of the magnetic body 24 is N pole (The end of the magnetic body 24 is near the second coil portion 982), once current passes through the first coil portion 981 and the second coil portion 982, a magnetic field effect of N pole is then generated by the first coil portion 981 and the second coil portion 982. An attractive force is generated between the first coil portion 981 and the magnetic body 24. A repulsive force is generated between the second coil portion 982 and the magnetic body 24. Alternately if the end of the magnetic body 24 is N pole (The end of the magnetic body 24 is near the first coil portion 981) and another end of the magnetic body 24 is S pole (The end of the magnetic body 24 is near the second coil portion 982), when current passes through the first coil portion 981 and the second coil portion 982, a magnetic field effect of S pole is generated by the first coil portion 981 and the second coil portion 982. An attractive force is generated between the first coil portion 981 and the magnetic body 24. A repulsive force is generated between the second coil portion 982 and the magnetic body 24. By the way mentioned above, the magnetic body 24 is moved toward the first coil portion 981 for insetting the magnetic body 24 into the opening 981a (not shown) of the first coil portion 981. The filter 22 is set on the sliding portion 983. The sliding portion 983 is connected to the magnetic body 24. The sliding portion 983 therefore slides with the magnetic body 24. The filter 22 can be removed from the viewing hole 18.

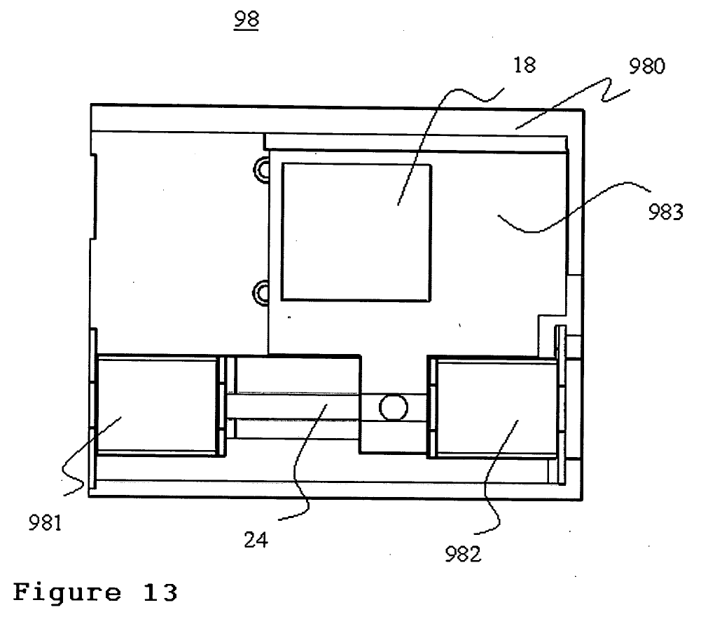

Referring to FIG. 13, a schematic diagram illustrates when the filter is in use for the filter driving apparatus. In the filter driving apparatus 98, if the end of the magnetic body 24 is S pole (The end of the magnetic body 24 is near the first coil portion 981) and another end of the magnetic body 24 is N pole (The end of the magnetic body 24 is near the second coil portion 982), when current passes through the first coil portion 981 and the second coil portion 982, a magnetic field effect of S pole is generated by the first coil portion 981 and the second coil portion 982. A repulsive force is generated between the first coil portion 981 and the magnetic body 24. An attractive force is generated between the second coil portion 982 and the magnetic body 24. Alternately if the end of the magnetic body 24 is N pole (The end of the magnetic body 24 is near the first coil portion 981) and another end of the magnetic body 24 is S pole (The end of the magnetic body 24 is near the second coil portion 982), when current passes through the first coil portion 981 and the second coil portion 982, a magnetic field effect of N pole is generated by the first coil portion 981 and the second coil portion 982. A repulsive force is then generated between the first coil portion 981 and the magnetic body 24. An attractive force is then generated between the second coil portion 982 and the magnetic body 24. Therefore, the magnetic body 24 is moved toward the second coil portion 982. The magnetic body 24 can be inset into the opening 982a (not shown) of the second coil portion 982. The filter 22 is set on the sliding portion 983. The sliding portion 983 is connected to the magnetic body 24. So the sliding portion 983 slides with the magnetic body 24. The filter 22 can be placed over or overlapped the viewing hole 18 as shown in FIG. 13.

The filter 22 of the present invention is composed of at least one optical film and can be an Infrared Rays (IR) Cut Filter or an IR Filter. Those filters are usually set at the front of the camera lens 72 for insulating stray light and IR cut. The camera 70 for use day and night, the filter 22 must be used for modification if ambient lights change too fast. The material of the filter 22 can be selected based on demands. The optical low pass filter (OLPF) is combined with the IR cut filter to be the filter while in low-resolution. The OLPF, the IR cut filter and the OLPF are combined to be the filter while in high-resolution.

Although the features and advantages of the embodiments according to the preferred invention are disclosed, it is not limited to the embodiments described above, but encompasses any and all modifications and changes within the spirit and scope of the following claims.

What is claimed is:

1. A filter driving apparatus, comprising:
a casing, a central top area of said casing having a viewing hole and a sliding channel formed on a top and a bottom side of said casing;
a sliding portion slid on said sliding channel, a filter set on said sliding portion;
a magnetic body connected to said sliding portion; and
a first coil portion, an axial of said first coil portion paralleled an axial of said magnetic body, wherein a magnetic field is generated by said first coil portion by inputting current, a repulsive force or an attractive force is generated between said first coil portion and said magnetic body, said magnetic body is removed from or inset in said first coil portion, said filter is placed or withdrawn from said viewing hole.

2. The filter driving apparatus of claim 1, wherein said first coil portion has an opening for containing said magnetic body while insetting.

3. The filter driving apparatus of claim 1, wherein when a polarity of said first coil portion differs from a polarity of said magnetic body, an attractive force is generated between said first coil portion and said magnetic body, said magnetic body is then moved toward said first coil portion.

4. The filter driving apparatus of claim 1, wherein when a polarity of said first coil portion is the same as a polarity of said magnetic body, a repulsive force is generated between said first coil portion and said magnetic body, said magnetic body is then removed from said first coil portion.

5. The filter driving apparatus of claim 1, wherein said filter is composed of at least one optical film.

6. The filter driving apparatus of claim 1, wherein said viewing hole further has a transparent film, said transparent film is a plastic sheet or a glass sheet.

7. The filter driving apparatus of claim 1, wherein said filter driving apparatus is applied for a camera.

8. The filter driving apparatus of claim 1, wherein said filter driving apparatus further comprises a second coil portion, an axial of said second coil portion parallels said axial of said magnetic body, a magnetic field is generated by said second coil portion by inputting current, said magnetic body is removed from or inset in said second coil portion.

9. The filter driving apparatus of claim 8, wherein said polarity of said first coil portion is same as a polarity of said second coil portion.

10. The filter driving apparatus of 8, wherein said first coil portion and said second coil portion are arranged at two ends of said magnetic body respectively.

11. A filter driving apparatus for a camera and a camera lens set within said camera, said filter driving apparatus comprising:
a casing, a central top area of said casing having a viewing hole and a sliding channel formed on a top and a bottom side of said casing, wherein said viewing hole corresponds to said camera lens;
a sliding portion slid on said sliding channel, a filter set on said sliding portion;
a magnetic body connected to said sliding portion; and
a first coil portion, an axial of said first coil portion paralleled an axial of said magnetic body, wherein a magnetic field is generated by said first coil portion by inputting current, a repulsive force or an attractive force is generated between said first coil portion and said magnetic body, said magnetic body is removed from or inset in said first coil portion, said filter is overlapped or withdrawn from said viewing hole.

12. The filter driving apparatus for a camera of claim 11, wherein said first coil portion has an opening for containing said magnetic body while insetting.

13. The filter driving apparatus for a camera of claim 11, wherein when said filter is used by said camera, a polarity of said first coil portion differs from a polarity of said magnetic body, an attractive force is generated between said first coil portion and said magnetic body, said magnetic body is moved toward said first coil portion, said filter is then placed over and overlapped said viewing hole.

14. The filter driving apparatus for a camera of claim 11, wherein when said filter is not used by said camera, said polarity of said first coil portion is the same as said polarity of said magnetic body, a repulsive force is generated between said first coil portion and said magnetic body, said magnetic body is removed from said first coil portion, said filter is then withdrawn from said viewing hole.

15. The filter driving apparatus for a camera of claim 11, wherein said filter is composed of at least one optical film.

16. The filter driving apparatus for a camera of claim 11, wherein said viewing hole further has a transparent film, said transparent film is a plastic sheet or a glass sheet.

17. The filter driving apparatus for a camera of claim 11, wherein said filter driving apparatus further comprises a second coil portion, an axial of said second coil portion parallels said axial of said magnetic body, a magnetic field is generated by said second coil portion by inputting currents, said magnetic is removed from or inset in said second coil portion.

18. The filter driving apparatus for a camera of claim 17, wherein said polarity of said first coil portion is the same as said polarity of said second coil portion.

19. The filter driving apparatus for a camera of claim 18, wherein said first coil portion and said second coil portion are arranged at two ends of said magnetic body respectively.
